(19) United States
(12) Patent Application Publication
(10) Pub. No.: US 2024/0402399 A1
(43) Pub. Date: Dec. 5, 2024

(54) COMPONENT FOR DATA GLASSES, AND DATA GLASSES

(71) Applicant: ams-OSRAM International GmbH, Regensburg (DE)

(72) Inventor: Joerg Erich SORG, Regensburg (DE)

(21) Appl. No.: 18/698,055

(22) PCT Filed: Sep. 22, 2022
(86) PCT No.: PCT/EP2022/076370

§ 371 Date: Apr. 3, 2024

(30) Foreign Application Priority Data
Oct. 4, 2021 (DE) 10 2021 125 627.5

(51) Int. Cl. G02B 3/10; G02B 3/08

(52) U.S. Cl. CPC G02B 3/10; G02B 3/08

(57) ABSTRACT

A component (20) for data glasses (21) is provided, the component (20) comprising a radiation source (22), which is designed to emit electromagnetic radiation during operation, a multifocal element (23) with at least a first region (24) and at least a second region (25), and an imaging system (26), which is designed to image electromagnetic radiation emitted by the radiation source (22) into a region outside the component (20), wherein the first region (24) comprises an invariable first refractive power and the second region (25) comprises an invariable second refractive power different from the first refractive power, the multifocal element (23) is arranged in the imaging system (26), and the first region (24) and the second region (25) are arranged concentrically to each other. Furthermore, data glasses (21) are disclosed.

### RELATED APPLICATION(S)

This application is a US National Stage Application of International Application PCT/EP2022/076370, filed on 22 Sep. 2022, and claims priority under 35 U.S.C. § 119 (a) and 35 U.S.C. § 365 (b) from German Patent Application DE 10 2021 125 627.5, filed on 4 Oct. 2021, the contents of which are incorporated herein by reference in their entirety.

### TECHNICAL FIELD

The present disclosure relates to a component for data glasses and data glasses.

### BACKGROUND

Data glasses can be used to display an augmented reality or a virtual reality. Thereby, images are imaged onto a person's retina. If this person comprises ametropia, i.e. defective vision, it is necessary to adapt the data glasses to the person's visual acuity. Thus, a costly, individual adaptation of data glasses is often required.

### SUMMARY

Various embodiments of the present disclosure relate to a component for data glasses, wherein the data glasses can be used in the case of ametropia. Some embodiments relate to data glasses which can be used in the case of ametropia.

According to at least one embodiment of the component for data glasses, the component comprises a radiation source which is designed to emit electromagnetic radiation during operation. The radiation source can comprise a laser or a light-emitting diode. If the radiation source comprises a laser, the radiation source is designed to emit laser radiation during operation. If the radiation source comprises a light-emitting diode, the radiation source is designed to emit light during operation.

According to at least one embodiment of the component for data glasses, the component comprises a multifocal element with at least a first region and at least a second region. The multifocal element can comprise a multifocal lens or the multifocal element can be a multifocal lens. The first region and the second region can be arranged concentrically to each other. The multifocal element can comprise at least two different focal planes. This means that the different focal planes are arranged spaced apart from each other. It is possible that the multifocal element further comprises at least one third region. In this case, the multifocal element can comprise at least three different focal planes. The multifocal element may comprise a total of more than one first region and/or more than one second region. In total, the multifocal element can comprise more than two different regions.

According to at least one embodiment of the component for data glasses, the component comprises an imaging system which is designed to image electromagnetic radiation emitted by the radiation source into a region outside the component. This can mean that the imaging system is designed to image electromagnetic radiation emitted by the radiation source into a region outside the component. The region outside the component may be the retina of an eye. The imaging system can comprise one optical element or more optical elements for imaging. The imaging system can be arranged on a radiation exit side of the radiation source.

According to at least one embodiment of the component for data glasses, the first region comprises an invariable first refractive power and the second region comprises an invariable second refractive power different from the first refractive power. This can mean that electromagnetic radiation can be imaged into a first focal plane by the first region of the multifocal element. The multifocal element can be designed to image radiation impinging on the multifocal element through the first region into a first focal plane. Electromagnetic radiation can be imaged through the second region of the multifocal element into a second focal plane. The multifocal element can be designed to image radiation impinging on the multifocal element through the second region into a second focal plane. The first focal plane is different from the second focal plane. That the first refractive power and the second refractive power are different can mean that they cannot be set or adjusted. The first refractive power and the second refractive power are therefore properties of the multifocal element which cannot be changed or adjusted. The multifocal element is therefore a passive optical element.

According to at least one embodiment of the component for data glasses, the multifocal element is arranged in the imaging system. This can mean that the imaging system comprises the multifocal element. The multifocal element can be a part of the imaging system.

According to at least one embodiment of the component for data glasses, the component comprises a radiation source, which is designed to emit electromagnetic radiation during operation, a multifocal element with at least a first region and at least a second region, and an imaging system, which is designed to image electromagnetic radiation emitted by the radiation source into a region outside the component, wherein the first region comprises an invariable first refractive power and the second region comprises a second refractive power different from the first refractive power, and the multifocal element is arranged in the imaging system.

The component described herein is based, among other things, on the idea that the data glasses in which the component is arranged can be used with different visual acuities without a further individual adjustment. For this, the component comprises the multifocal element. The multifocal element enables that electromagnetic radiation is imaged simultaneously in different focal planes. If, for example, an image is imaged, the image is imaged into focal planes that are spaced apart from each other.

In many people, images perceived by the eye are not focused directly on the retina but in a region in front of or behind the retina. In this case, there is ametropia or defective vision. An ametropia can be compensated for with visual aids such as glasses or contact lenses. When using the visual aid, perceived images are focused directly onto the retina. However, it is often difficult to use glasses or contact lenses simultaneously with data glasses. With the component described herein, images can be imaged in different focal planes spaced apart from each other. This means that when the data glasses are used with the component, images can be imaged in different regions in front of or behind the retina or on the retina. This is achieved by the multifocal element imaging an image or electromagnetic radiation into different focal planes. Depending on how the eye of the person wearing the data glasses with the component is structured, the images or electromagnetic radiation imaged by the component are imaged in different planes within the eye. For example, for a first person, the image imaged in a first focal plane can be imaged directly on the retina. This first person then sees the image displayed in the first focal plane sharply. For a second person, for example, the image imaged in a second focal plane can be imaged directly onto the retina. This second person then sees the image displayed in the second focal plane sharply.

When an image is displayed in different focal planes, people only perceive the image that appears sharpest to the respective person, i.e. the one with the best image quality. Thus, depending on the person's defective vision, one of the images from the different focal planes is imaged sharply on the retina or at least one of the images is imaged most sharply in comparison to the images of the other focal planes. The images of the remaining focal planes are suppressed by the visual center, i.e. they are not perceived. The component described herein thus utilizes this effect to the extent that electromagnetic radiation is imaged in different focal planes and that persons with different visual acuity perceive the imaged electromagnetic radiation of one focal plane in each case. It is therefore possible to image electromagnetic radiation or images in different focal planes with the component. However, a person wearing the data glasses with the component only perceives electromagnetic radiation or images of one of these focal planes. Thus, the data glasses with the component can be used by people with different visual acuity. This has the advantage that the component does not have to be individually adapted for different people to their visual acuity, but can be used by different people with different visual acuities. Thereby, people with different visual acuities can perceive the displayed images sharply. Thus, the data glasses with the component can also be used by ametropia, i.e. defective vision. Thereby, an adjustment to the individual defective vision is not necessary. It is also possible to use the data glasses if there is no defective vision. The multifocal element can be constructed in such a way that one of the focal planes of the multifocal element lies on the retina in the event that there is no defective vision. This means that the data glasses can advantageously be used both by people with defective vision and by people without defective vision.

According to at least one embodiment of the component for data glasses, the component is designed to image electromagnetic radiation simultaneously in a first focal plane and in a second focal plane different from the first focal plane, wherein the positions of the first focal plane and the second focal plane are invariable. This is made possible by the multifocal element. So, the multifocal element is designed to image electromagnetic radiation simultaneously in at least two different focal planes. The positions of these focal planes cannot be adjusted. The component as a whole is also designed to image electromagnetic radiation simultaneously in different focal planes, the positions of which are invariable. This means that the positions of the first focal plane and the second focal plane cannot be adjusted. The component comprises no active component for adjusting the positions of the focal planes. Thus, the positions of the first focal plane and the second focal plane are set by the structure of the component. The first focal plane and the second focal plane can be arranged one behind the other. So, the first focal plane can comprise a greater distance to the component than the second focal plane. Alternatively, the second focal plane comprises a greater distance to the component than the first focal plane. The component can further be designed to image the same electromagnetic radiation simultaneously in the first focal plane and in the second focal plane. For example, the component can be designed to image the same images simultaneously in the first focal plane and in the second focal plane. This means that the images displayed in the different focal planes are superimposed. This enables that the data glasses can be used by people with different visual acuities.

According to at least one embodiment of the component for data glasses, the component is designed to image electromagnetic radiation simultaneously in at least three different focal planes, wherein the positions of the focal planes are invariable.

According to at least one embodiment of the component for data glasses, the component is designed to image electromagnetic radiation simultaneously in a plurality of different focal planes, wherein the positions of the focal planes are invariable.

According to at least one embodiment of the component for data glasses, the first refractive power and the second refractive power differ from each other by at least 0.5 diopter. This makes it possible that the data glasses with the component can be used by people with visual acuities that differ by at least 0.5 diopter. The multifocal element can comprise further regions whose refractive power can each be different from the first refractive power and the second refractive power. The data glasses with the component can be used by persons with different visual acuities, wherein the visual acuities can differ from each another by at least 0.5 diopter. It is further possible that the first refractive power and the second refractive power to differ from each other by at least 0.25 diopter, at least 0.75 diopter or at least 1 diopter. The multifocal element can comprise further regions, whose refractive power each differs by at least 0.5 diopter from the first refractive power and the second refractive power.

According to at least one embodiment of the component for data glasses, the first refractive power and the second refractive power differ from each other by at least 2 diopter. Thereby, the multifocal element can comprise further regions, whose refractive power each lies between the first refractive power and the second refractive power. Thus, with the component a range of visual acuities of at least 2 diopter can be covered. The first refractive power and the second refractive power can differ from each other by at least 3 diopter or at least 5 diopter.

According to at least one embodiment of the component for data glasses, the multifocal element comprises at least a third region comprising an invariable third refractive power which is different from the first refractive power and the second refractive power and wherein the first refractive power and the third refractive power differ from each other by at least 2 diopter. The second refractive power lies between the first refractive power and the third refractive power. The multifocal element can comprise further regions whose refractive power each lies between the first refractive power and the third refractive power. Thereby, the refractive power of adjacent regions can each differ from each other by at least 0.5 diopter or at least 0.75 diopter. Thus, with the component a range of visual acuities of at least 2 diopter can be covered. The first refractive power and the third refractive power can differ from each other by at least 3 diopter or at least 5 diopter.

According to at least one embodiment of the component for data glasses, the imaging system comprises a deflection element which is designed to deflect electromagnetic radiation impinging on the deflection element in different directions. The deflection element can be designed to direct electromagnetic radiation impinging on the deflection element in different directions at different times. For example, the deflection element is designed to deflect electromagnetic radiation impinging at a first point in time in a first direction and to deflect electromagnetic radiation impinging at a second point in time in a second direction different from the first direction. The deflection element can be designed to deflect impinging electromagnetic radiation in total in such a way that a 2-dimensional image is displayed. This image can be imaged by the component onto the retina of an eye. Thus, through the data glasses images of an augmented reality or a virtual reality can be imaged.

According to at least one embodiment of the component for data glasses, the deflection element comprises at least one optical element which is rotatable along at least one axis. The optical element may be a mirror. The mirror can be a MEMS (micro-electro-mechanical system) mirror. The mirror can comprise a diameter of at least 0.1 mm and at most 5 mm. The deflection element can be designed to move the optical element with a frequency of at least 5 kHz and at most 200 kHz. Via the optical element, electromagnetic radiation impinging on the deflection element can be deflected in different directions. In order to achieve a deflection in different directions, the optical element is at least partially rotated or turned around the axis. This enables the deflection of impinging electromagnetic radiation in directions, which point at a line. It is further possible that the optical element is rotatable along two different axes. Thereby, the two axes can run perpendicular to each other. This enables the deflection of impinging electromagnetic radiation in directions which point to a surface. Thus, a 2-dimensional image can be imaged. This can also be achieved by the deflection element comprising a further optical element. The further optical element can be a mirror. The mirror can be a MEMS mirror. The mirror can comprise a diameter of at least 0.1 mm and at most 5 mm. The deflection element can be designed to move the further optical element with a frequency of at least 50 Hz and at most 1 kHz.

According to at least one embodiment of the component for data glasses, the deflection element is arranged between the radiation source and the multifocal element. This means that the electromagnetic radiation emitted by the radiation source is first deflected by the deflection element and displays, for example, a 2-dimensional image and, subsequently, this image is imaged into different focal planes by the multifocal element. This enables that the data glasses can be used by people with different visual acuities.

According to at least one embodiment of the component for data glasses, the imaging system comprises a beam shaping element which is designed to change the beam diameter of the electromagnetic radiation impinging on the beam shaping element. The beam shaping element can be designed to increase or decrease the beam diameter of the electromagnetic radiation impinging on the beam shaping element. The beam shaping element can comprise one or more lenses. It is further possible that the beam shaping element comprises a diffuser. With the beam shaping element the beam diameter of the electromagnetic radiation, which is intended for emission from the component, can be adjusted to the required size.

According to at least one embodiment of the component for data glasses, the multifocal element is arranged in the beam shaping element. This can mean that the beam shaping element comprises the multifocal element. Thus, the multifocal element is a part of the beam shaping element. Thereby, the multifocal element can be arranged in the beam shaping element in such a way that the remaining optical elements of the beam shaping element are arranged between the radiation source and the multifocal element. Thus, the electromagnetic radiation to be emitted by the component can be imaged through the multifocal element into different focal planes.

According to at least one embodiment of the component for data glasses, the imaging system comprises a two-dimensional waveguide. The 2-dimensional waveguide can be designed to guide electromagnetic radiation. Thus, electromagnetic radiation emerging from the beam shaping element can be guided in the 2-dimensional waveguide. The two-dimensional waveguide can be arranged on a radiation exit side of the component. In this way, electromagnetic radiation emitted by the radiation source can emerge from the component through the 2-dimensional waveguide. This enables imaging of a 2-dimensional image.

According to at least one embodiment of the component for data glasses, the multifocal element is arranged between the radiation source and the two-dimensional waveguide. Thus, the component enables that electromagnetic radiation emitted by the radiation source is imaged through the multifocal element into several different focal planes.

According to at least one embodiment of the component for data glasses, the imaging system comprises a detection element which is designed to detect the viewing direction of an eye. This can mean that the detection element is designed to detect the viewing direction of an eye of a person, which is wearing the data glasses. The detection element is further designed to detect a change in the viewing direction of an eye. The detection element can also be designed to detect the speed of a movement of an eye and/or the direction of movement of an eye. This enables that an image imaged by the component is imaged in the direction in which the eye is looking or that the image is changed according to the detected viewing direction.

According to at least one embodiment of the component for data glasses, the detection element comprises a controller and an optical element, wherein the controller is designed to move the optical element. The optical element can be designed to deflect the electromagnetic radiation impinging on the optical element. Thus, with the detection element the electromagnetic radiation, which is intended for emission by the component, can be deflected in the direction of the detected viewing direction. This means that the optical element is controlled by the controller in such a way that the optical element follows the movement of the eye. The optical element can be a mirror. The mirror can be rotatable around at least one axis. The mirror can be a MEMS mirror. This enables that an image imaged by the component is imaged in the direction in which the eye is looking or that the image is changed according to the detected viewing direction. It is further possible that the controller is designed to move the optical element depending on the data provided by the detection element. The detection element can be designed to detect the viewing direction of an eye, the speed of a movement of an eye and/or the direction of movement of an eye. Based on this detected data, the controller can control the optical element. This means that the optical element can be moved in such a way that an image imaged by the component is imaged in the direction in which the eye is looking and/or in which the eye is moving.

According to at least one embodiment of the component for data glasses, the multifocal element is arranged between the radiation source and the detection element. Thus, the component enables that electromagnetic radiation emitted by the radiation source is imaged through the multifocal element into several different focal planes.

According to at least one embodiment of the component for data glasses, the imaging system comprises a holographic mirror. The holographic mirror can be at least partially translucent for electromagnetic radiation emitted by the radiation source. The holographic mirror can be used to display an augmented reality with the data glasses. Thereby, through the holographic mirror at least one image can be imaged in the field of view of the person, which is wearing the data glasses.

According to at least one embodiment of the component for data glasses, the multifocal element is arranged between the radiation source and the holographic mirror. Thus, the component enables that electromagnetic radiation emitted by the radiation source is imaged by the multifocal element into several different focal planes.

According to at least one embodiment of the component for data glasses, the data glasses are configured to display an augmented reality. This means that the data glasses can be AR (augmented reality) data glasses.

According to at least one embodiment of the component for data glasses, the data glasses are configured to display a virtual reality. This means that the data glasses can be VR (virtual reality) data glasses.

Further, data glasses are provided. According to at least one embodiment of the data glasses, the data glasses comprise the component for data glasses. In other words, all features disclosed for the component are also disclosed for the data glasses.

### BRIEF DESCRIPTION OF THE DRAWINGS

In the drawings, elements that are identical, similar or have the same effect are marked with the same reference signs in the figures. The figures and the proportions of the elements shown in the figures are not to be regarded as being true to scale. Rather, individual elements may be shown exaggeratedly large for better visualization and/or better comprehensibility

FIG. 1 shows a component for data glasses according to an exemplary embodiment.

FIG. 2A shows an example of a lens.

FIGS. 2B and 2C each show an exemplary embodiment of a multifocal element.

FIGS. 3 and 4 show further exemplary embodiments of a component for data glasses.

FIG. 5 shows data glasses according to an exemplary embodiment.

### DETAILED DESCRIPTION

In the following, the component for data glasses described herein and the data glasses described herein are explained in more detail in conjunction with exemplary embodiments and the associated figures.

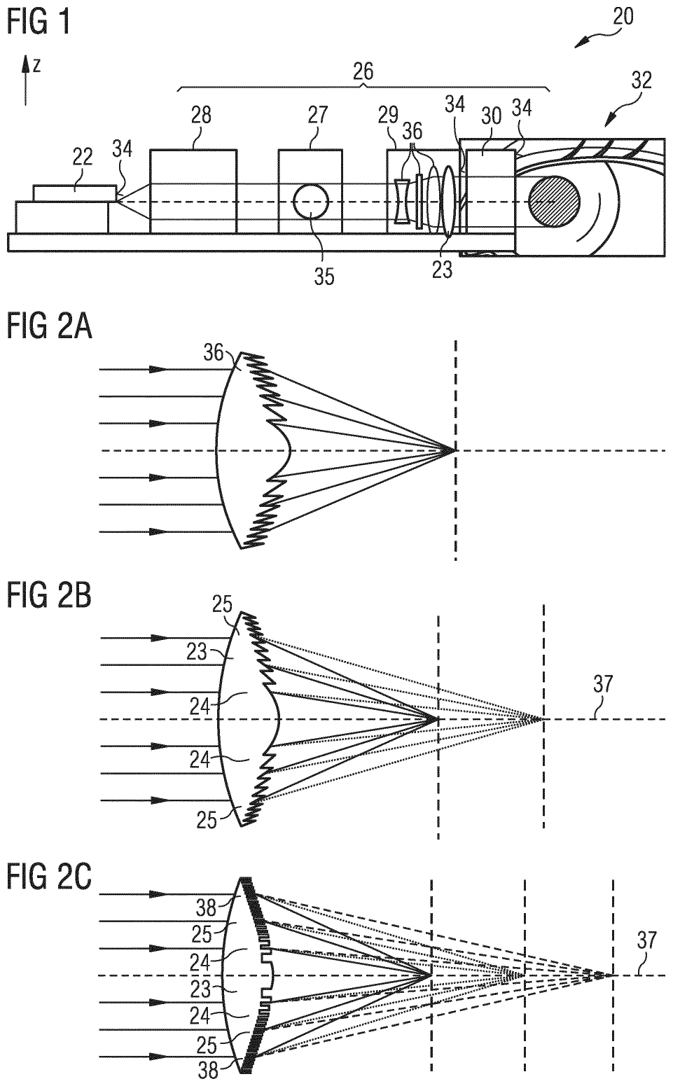

FIG. 1 shows an exemplary embodiment of a component 20 for data glasses 21. The component 20 comprises a radiation source 22, which is designed to emit electromagnetic radiation during operation. The radiation source 22 may be a laser. The component 20 further comprises an optical element 28. The optical element 28 is arranged spaced apart from a radiation exit side 34 of the radiation source 22. The optical element 28 may be a lens, a reflector or a planar waveguide circuit. The optical element 28 is designed to shape the electromagnetic radiation emitted by the radiation source 22. In FIG. 1, it is shown that the optical element 28 deflects the impinging electromagnetic radiation so that the beams emerging from the optical element 28 propagate parallel to each other. This means the optical element 28 can comprise a collimator or a converging lens.

The component 20 further comprises an imaging system 26, which is designed to image electromagnetic radiation emitted by the radiation source 22 into area region outside the component 20. The imaging system 26 comprises a deflection element 27, which is designed to deflect electromagnetic radiation impinging on the deflection element 27 in different directions. The deflection element 27 comprises a mirror 35, which is rotatable along at least one axis. The mirror 35 is designed to deflect electromagnetic radiation impinging on the deflection element 27 in such a way that a 2-dimensional image is displayed. The optical element 28 is arranged between the radiation source 22 and the deflection element 27.

The imaging system 26 further comprises a beam shaping element 29. The beam shaping element 29 is designed to change the beam diameter of the electromagnetic radiation impinging on the beam shaping element 29. For this, the beam shaping element 29 comprises several lenses 36. In the exemplary embodiment shown in FIG. 1, the beam shaping element 29 is designed to increase the beam diameter of the impinging electromagnetic radiation. Thus, the beam diameter of the electromagnetic radiation emerging from the beam shaping element 29 is larger than the beam diameter of the electromagnetic radiation impinging on the beam shaping element 29. FIG. 1 shows a side view of the component 20, so that a cross-section through the electromagnetic radiation is shown. The beam diameter is thus given in a vertical direction z, wherein the vertical direction z runs perpendicular to the main direction of propagation of the electromagnetic radiation. The deflection element 27 is arranged between the beam shaping element 29 and the optical element 28.

The component 20 further comprises a multifocal element 23, wherein the multifocal element 23 comprises at least a first region 24 and at least a second region 25. Thereby, the first region 24 comprises an invariable first refractive power and the second region 25 comprises an invariable second refractive power different from the first refractive power. The multifocal element 23 is arranged in the imaging system 26. In the exemplary embodiment in FIG. 1, the multifocal element 23 is arranged in the beam shaping element 29. Thereby, the multifocal element 23 is arranged in the beam shaping element 29 between the lenses 36 and a radiation exit side 34 of the beam shaping element 29. Thus, the deflection element 27 is arranged between the radiation source 22 and the multifocal element 23. Furthermore, the deflection element 27 and the optical element 28 are arranged between the radiation source 22 and the beam shaping element 29.

The imaging system 26 further comprises a 2-dimensional waveguide 30. The waveguide 30 is arranged at a radiation exit side 34 of the component 20. Thus, the optical element 28, the deflection element 27, the beam shaping element 29 and the multifocal element 23 are arranged between the radiation source 22 and the waveguide 30. Electromagnetic radiation emerging from the component 20 can be imaged onto the retina of an eye 32.

FIG. 2A shows an example of a lens 36, which is not an exemplary embodiment. The lens 36 is a monofocal lens. This means that parallel electromagnetic radiation impinging on the lens 36 is bundled by the lens 36 into one focal plane. The position of the focal plane is depicted by a dashed line which runs perpendicular to the direction of propagation of the parallel, impinging electromagnetic radiation.

FIG. 2B shows an exemplary embodiment of the multifocal element 23. The multifocal element 23 is a bifocal lens. This means that parallel electromagnetic radiation impinging on the multifocal element 23 is bundled by the multifocal element 23 into two different focal planes. Thereby, the two focal planes are spatially spaced from each other. The positions of the two focal planes are depicted by dashed lines, which run perpendicular to the direction of propagation of the parallel, impinging electromagnetic radiation. The multifocal element 23 comprises a first region 24 with an invariable first refractive power and a second region 25 with an invariable second refractive power different from the first refractive power. The first region 24 and the second region 25 are arranged concentrically to each other. FIG. 2B shows a cross-section through the multifocal element 23 such that the first region 24 is closer to a center axis 37 through the multifocal element 23 than the second region 25. The center axis 37 through the multifocal element 23 runs parallel to the impinging electromagnetic radiation through the center of the multifocal element 23.

The component 20, which comprises the multifocal element 23, is thus designed to image electromagnetic radiation simultaneously in a first focal plane and in a second focal plane different from the first focal plane. Thereby, the positions of the first focal plane and the second focal plane are invariable. This is achieved by the fact that the first refractive power and the second refractive power are properties of the bifocal lens. The first refractive power and the second refractive power are caused by the shape of the multifocal element 23, which is why the first refractive power and the second refractive power and thus also the positions of the first focal plane and the second focal plane are invariable. The multifocal element 23 is therefore a passive optical element.

The first refractive power and the second refractive power can differ from each other by at least one diopter.

FIG. 2C shows a further exemplary embodiment of the multifocal element 23. The multifocal element 23 is a multifocal lens. This means that the multifocal element 23 is designed to bundle impinging electromagnetic radiation into at least two different focal planes. In the exemplary embodiment of FIG. 2C, the multifocal element 23 is designed to bundle impinging electromagnetic radiation into three different focal planes. Thereby, the three focal planes are spatially spaced. The positions of the three focal planes are depicted by dashed lines, which run perpendicular to the direction of propagation of the parallel, impinging electromagnetic radiation. The multifocal element 23 comprises a first region 24 with an invariable first refractive power, a second region 25 with an invariable second refractive power and a third region 38 with an invariable third refractive power. The first refractive power, the second refractive power and the third refractive power are each different from one another. The first region 24, the second region 25 and the third region 38 are arranged concentrically to each other. FIG. 2C shows a cross-section through the multifocal element 23 such that the first region 24 is located closer to a center axis 37 through the multifocal element 23 than the second region 25 and the third region 38. The second region 25 is located closer to the center axis 37 than the third region 38. The center axis 37 through the multifocal element 23 runs parallel to the impinging electromagnetic radiation through the center of the multifocal element 23.

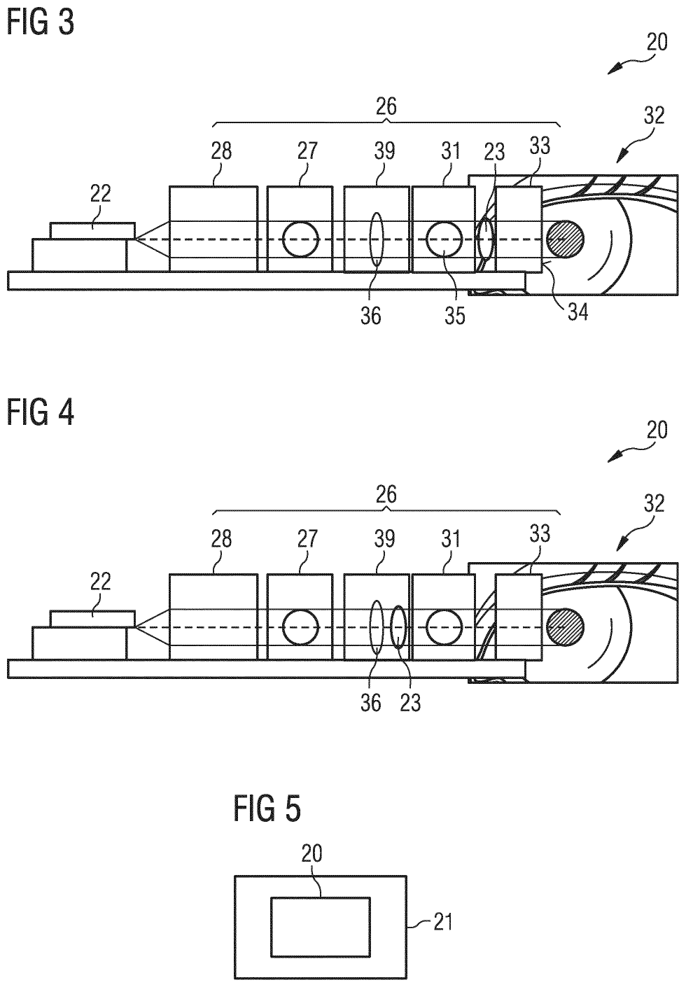

FIG. 3 shows a further exemplary embodiment of the component 20. In comparison to the exemplary embodiment shown in FIG. 1, the exemplary embodiment of FIG. 3 comprises no beam shaping element 29 and no waveguide 30. Instead, the imaging system 26 of the component 20 additionally comprises a further optical element 39, a detection element 31 and a holographic mirror 33. The further optical element 39 is arranged downstream of the deflection element 27. Thus, the deflection element 27 is arranged between the further optical element 39 and the optical element 28. The further optical element 39 is designed to shape impinging electromagnetic radiation and can comprise a lens 36.

The detection element 31 is arranged downstream of the further optical element 39. This means, the further optical element 39 is arranged between the deflection element 27 and the detection element 31. The detection element 31 is designed to detect the viewing direction of an eye 32. For this, the detection element 31 comprises a controller and an optical element, wherein the controller is designed to move the optical element in the direction of the detected viewing direction. The optical element is a mirror 35. The controller is not shown.

The multifocal element 23 is arranged downstream of the detection element 31. The detection element 31 is thus arranged between the multifocal element 23 and the further optical element 39.

The holographic mirror 33 is arranged downstream of the multifocal element 23. Thus, the multifocal element 23 is arranged between the detection element 31 and the holographic mirror 33. This means that the multifocal element 23 is also arranged between the radiation source 22 and the holographic mirror 33. Furthermore, the multifocal element 23 is arranged between the holographic mirror 33 and the deflection element 27. The holographic mirror 33 is arranged at a radiation exit side 34 of the component 20. Electromagnetic radiation emerging from the component 20 can be imaged onto the retina of an eye 32.

FIG. 4 shows a further exemplary embodiment of the component 20. In comparison to the exemplary embodiment shown in FIG. 3, the multifocal element 23 is arranged at a different position in the exemplary embodiment of FIG. 4. Thus, the multifocal element 23 is arranged in the further optical element 39. Thereby, the multifocal element 23 is arranged downstream of the lens 36 of the further optical element 39. Thus, the multifocal element 23 is arranged between the radiation source 22 and the detection element 31. At the same time, the multifocal element 23 is arranged between the deflection element 27 and the detection element 31. Furthermore, the multifocal element 23 is arranged between the deflection element 27 and the holographic mirror 33.

For the exemplary embodiments of the component 20 for data glasses 21 shown in FIGS. 1, 3 and 4, the data glasses 21, in which the component 20 can be arranged, can be configured to display an augmented or virtual reality.

FIG. 5 schematically shows an exemplary embodiment of data glasses 21. The data glasses 21 comprise the component 20.

The features and exemplary embodiments described in connection with the figures can be combined with one another in accordance with further exemplary embodiments, even if not all combinations are explicitly described. Furthermore, the exemplary embodiments described in connection with the figures may alternatively or additionally comprise further features as described in the general part.

The present disclosure is not limited to the description based on the disclosed embodiments. Rather, the present disclosure includes any new feature as well as any combination of features, which includes in particular any combination of features in the patent claims, even if this feature or this combination itself is not explicitly stated in the patent claims or exemplary embodiments.

### REFERENCES

20 component
21 data glasses
22 radiation source
23 multifocal element
24 first region
25 second region
26 imaging system
27 deflection element
28 optical element
29 beam shaping element
30 waveguide
31 detection element
32 eye
33 holographic mirror
34 radiation exit side
35 mirror
36 lens
37 center axis
38 third region
39 further optical element
z vertical direction

1. A component for data glasses, the component comprising:
a radiation source designed to emit electromagnetic radiation during operation,
a multifocal element with at least a first region and at least a second region, and
an imaging system designed to image electromagnetic radiation emitted from the radiation source into a region outside the component, wherein
the first region comprises an invariable first refractive power and the second region comprises an invariable second refractive power different from the first refractive power,
the multifocal element is arranged in the imaging system, and
the first region and the second region are arranged concentrically to each other, and
the component is designed to image electromagnetic radiation simultaneously at least in a first focal plane and in a second focal plane different from the first focal plane.

2. The component for data glasses according to claim 1, wherein the positions of the first focal plane and the second focal plane are invariable.

3. The component for data glasses according to claim 1, wherein the first refractive power and the second refractive power differ from each other by at least 0.5 diopter.

4. The component for data glasses according to claim 1, wherein the imaging system comprises a deflection element designed to deflect electromagnetic radiation impinging on the deflection element in different directions.

5. The component for data glasses according to claim 4, wherein the deflection element comprises at least one optical element which is rotatable along at least one axis.

6. The component for data glasses according to claim 4, wherein the deflection element is arranged between the radiation source and the multifocal element.

7. The component for data glasses according to claim 1, wherein the imaging system comprises a beam shaping element designed to change the beam diameter of the electromagnetic radiation impinging on the beam shaping element.

8. The component for data glasses according to claim 7, wherein the multifocal element is arranged in the beam shaping element.

9. The component for data glasses according to claim 1, wherein the imaging system comprises a two-dimensional waveguide.

10. The component for data glasses according to claim 9, wherein the multifocal element is arranged between the radiation source and the two-dimensional waveguide.

11. The component for data glasses according to claim 1, wherein the imaging system comprises a detection element, which is designed to detect the viewing direction of an eye.

12. The component for data glasses according to claim 11, wherein the detection element comprises a controller and an optical element, wherein the controller is designed to move the optical element.

13. The component for data glasses according to claim 11, wherein the multifocal element is arranged between the radiation source and the detection element.

14. The component for data glasses according to claim 1, wherein the imaging system comprises a holographic mirror.

15. The component for data glasses according to claim 14, wherein the multifocal element is arranged between the radiation source and the holographic mirror.

16. The component for data glasses according to claim 1, wherein the data glasses are configured for displaying an augmented reality.

17. Data glasses comprising the component according to claim 1.
